(19) United States
(12) Patent Application Publication
(10) Pub. No.: US 2014/0242531 A1
(43) Pub. Date: Aug. 28, 2014

(54) REACTION CONTAINER AND VACUUM HEAT TREATMENT APPARATUS HAVING THE SAME

(71) Applicant: Byung Sook Kim, Seoul (KR)

(72) Inventor: Byung Sook Kim, Seoul (KR)

(73) Assignee: LG INNOTEK CO., LTD., Seoul (KR)

(21) Appl. No.: 14/342,104

(22) PCT Filed: Aug. 31, 2012
(86) PCT No.: PCT/KR2012/007026

§ 371 Date: Feb. 28, 2014

(30) Foreign Application Priority Data
Aug. 31, 2011 (KR) 10-2011-0088196

(51) Int. Cl. F27B 14/08; F27B 14/04

(52) U.S. Cl. CPC F27B 14/08; F27B 14/04; F27B 2014/045; F27B 2014/0843
USPC 432/265

(57) ABSTRACT

A method of fabricating a reaction container according to the disclosure comprises putting graphite power in a molded member; and pressing the molded member, wherein the graphite powder comprises first graphite powder and second graphite powder having different particle sizes. A vacuum heat treatment apparatus comprises a chamber, a reaction container in the chamber, and a heat member heating the reaction container in the chamber, in which the reaction container comprises graphite, and the reaction container has a concentration in the range of 1.8 to 2.0.

### TECHNICAL FIELD

The disclosure relates to a reaction container and a vacuum heat treatment apparatus having the same.

### BACKGROUND ART

A vacuum heat treatment apparatus refers to an apparatus to obtain a desirable material by performing heat treatment with respect to a raw material in a crucible. Since the vacuum heat treatment apparatus performs heat treatment in a vacuum state, the material is not contaminated from surroundings. In the vacuum heat treatment apparatus, after placing an adiabatic member in a chamber maintained in a vacuum state, a heater is placed in the adiabatic member to heat the raw material.

However, a material generated during the reaction between the crucible and the raw material may adhere to an inner wall of the crucible. Because the generated material differs from a material of the crucible, a thermal stress is applied to the crucible due to a difference of expansion coefficients between hetero materials. When the difference of expansion coefficients is great, the crucible may be damaged due to the thermal stress during the reaction. Accordingly, the cost is increased due to the replacement of the crucible so that the productivity may be degraded.

According to the related art, a buffer part is disposed in a reaction container to prevent a material generated during the reaction from being deposited inside the crucible, thereby preventing the crucible from being cracked or broken caused by the difference of thermal expansions between a deposited material or a product and the crucible.

Further, according to the related art, a shape of the reaction container is transformed to prevent the material generated during the reaction from being deposited in the crucible, thereby preventing the crucible from being cracked or broken. That is, there is a method of compensating for the difference of thermal expansions between the crucible and a reaction product by transforming the shape of the reaction container.

However, according to the above method, when the material generated during the reaction is excessively deposited, the crucible may still be cracked and broken. That is, because the difference of thermal expansions in hetero materials between the reaction product and the crucible is significantly great, the above method may represent limitations on blocking a stress applied to the crucible caused by the difference of thermal expansions between hetero materials.

Accordingly, there is a need to provide a method capable of preventing crack and breakage of the crucible due to a stress derived from the difference of thermal expansions between the reaction product and the crucible without transforming the shape and structure of the crucible.

### DISCLOSURE OF INVENTION

### Technical Problem

The embodiment provides a reaction container in which breaking can be prevented and a vacuum heat treatment apparatus having the same.

### Solution to Problem

According to the embodiment, there is provided a method of fabricating a reaction container comprising forming a molded member by pressing graphite powder; and fabricating the reaction container by processing the molded member, wherein the graphite powder has a particle size in a range of about 10 μm to about 100 μm.

According to the embodiment, there is provided a vacuum heat treatment apparatus comprising a chamber, a reaction container in the chamber; and a heat member heating the reaction container in the chamber, wherein the reaction container comprises graphite, and the graphite has a particle size in a range of 10 μm to 100 μm.

### Advantageous Effects of Invention

A reaction container according to an embodiment can be fabricated by a graphite powder having a particle size in the range of 10 μm to 100 μm.

Accordingly, the reactivity of the graphite powder and SiO gas penetrated through pores of the graphite powder can be reduced.

That is, the graphite powder has a particle size in the range of 10 μm to 100 μm to reduce the reactivity of the SiO gas and the graphite powder. Therefore, the generation of SiC can be reduced.

Accordingly, the generation of the SiC is reduced in the reaction container to prevent the reaction container from being cracked and broken due to the difference of thermal expansions between the SiC and graphite.

Therefore, the crack and breakage of the reaction container can be prevented so that the manufacturing efficiency can be improved and the manufacturing cost can be reduced by reducing the replacement or repair work of the reaction container when manufacturing a silicon carbide powder by using a vacuum heat treatment apparatus comprising the reaction container.

### BRIEF DESCRIPTION OF DRAWINGS

FIG. 1 is a flowchart showing a method of fabricating a reaction container according to an embodiment; and

FIG. 2 is a schematic view showing a reaction container according to an embodiment.

### MODE FOR THE INVENTION

In the description of the embodiments, it will be understood that, when a layer (or film), a region, a pattern, or a structure is referred to as being “on” or “under” another substrate, another layer (or film), another region, another pad, or another pattern, it can be “directly” or “indirectly” on the other substrate, layer (or film), region, pad, or pattern, or one or more intervening layers may also be present. Such a position of the layer has been described with reference to the drawings.

The thickness and size of each layer shown in the drawings may be exaggerated, omitted or schematically drawn for the purpose of convenience or clarity. In addition, the size of elements does not utterly reflect an actual size.

Hereinafter, the embodiment of the present invention will be described with reference to accompanying drawings.

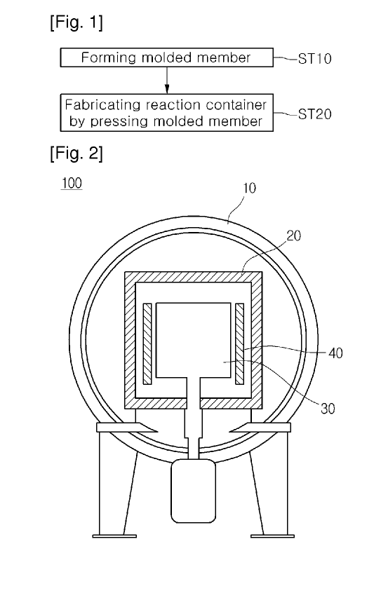

FIG. 1 is a schematic view showing a reaction container according to an embodiment.

Referring to FIG. 1, a method of fabricating a reaction container according to the embodiment comprises forming a molded member by pressing graphite powder (ST10), and fabricating the reaction container by processing the molded member (ST20), in which the graphite powder may have a particle size in the range of about 10 μm to about 100 μm.

In a step ST10 of forming a molded member by pressing a graphite powder, the graphite powder is pressed to from the molded member.

Although the molded member may be pressed and formed using a scheme such as extrusion, molding or cold isostatic press (CIP), the embodiment is not limited thereto. That is, the molded member may be fabricated using various forming schemes.

After that, in a step ST20 of fabricating the reaction container by processing the molded member, the graphite molded member is processed in the shape of a reaction container or a crucible so that a reaction container can be obtained as a final product.

The graphite powder may have a particle size in the range of 10 μm to 100 μm. Preferably, the graphite powder may have a particle size in the range of 15 μm to 100 μm. More preferably, the graphite powder may have a particle size in the range of about 15 μm to about 50 μm.

A reaction container according to the related art may be fabricated using a graphite powder having a particle size in the range of about 3 μm to about 10 μm. Further, when fabricating the reaction container using the graphite powder having a particle size in the range of about 3 μm to about 10 μm, the porosity of the reaction container may be in the range of about 20% to about 30%.

Pores between graphite particles in the reaction container may become a factor causing the breakage of the reaction container. That is, when a mixed raw material comprising a carbon source and a silicon source reacts in the reaction container, SiO gas by the reaction may penetrate through pores in the reaction container. In this case, SiO gas penetrating into the reaction container through the pores may react with a graphite to generate silicon carbide (SiC) serving as a reaction product.

Accordingly, a stress is applied to the reaction container due to the difference of thermal expansions between the SiC generated in the reaction container by the reaction and the graphite, so the reaction container is cracked or broken.

The reactivity of the SiC gas and the graphite may be changed according to the particle size of the graphite powder. That is, if the particle size of the graphite powder is small, the reactivity is increased which leads to the increase of generation of the silicon carbide. Meanwhile, if the particle size of the graphite powder is large, the re-activity is reduced which leads to the reduction of the generation of the silicon carbide.

The method of fabricating a reaction container according to the embodiment increases the particle size of the graphite powder to the range of about 10 μm to about 100 μm, preferably, about 15 μm to about 100 μm, more preferably, about 15 μm to about 50 μm, so that the reactivity is reduced which results in the reduction in generation of SiC by the reaction.

In this case, when the particle size of the graphite powder exceeds about 100 μm, a fracture strength of the reaction container is degraded, thereby causing other problems. Accordingly, the particle size of the graphite powder is limited to less than or equal to 100 μm.

Therefore, because the reaction container fabricated according to the embodiment may make the particle size of the graphite powder large to reduce a reaction product by the reaction, crack or breakage due to the difference of thermal expansions between the silicon carbide serving as a reaction product and the graphite may be reduced.

FIG. 2 is a flowchart showing a method of fabricating a reaction container according to an embodiment.

Referring to FIG. 2, the vacuum heat treatment apparatus according to the embodiment comprises a chamber, a reaction container disposed in the chamber, and a heat member heating the reaction container in the chamber, in which the reaction contain may comprise a graphite, and the graphite may have a particle size in the range of about 10 μm to about 100 μm.

The vacuum heat treatment apparatus according to the embodiment will be described in detail.

Atmosphere gas is injected around a chamber 100 through an atmosphere gas supply pipe (not shown). The atmosphere gas may comprise inert gas such as argon (Ar) or helium (He).

An adiabatic member 20 placed in the chamber 10 serves to insulate heat such that the reaction container 30 may maintain at a suitable temperature for the reaction. The adiabatic member 20 may comprise graphite having endurance against the high temperature.

The reaction container 30 filled with a mixed raw material to generate a desirable material through the reaction of the mixed raw material is placed in the adiabatic member 20. The reaction container 30 may comprise graphite so that the reaction container 30 can endure against the high temperature.

The graphite may have a particle size in the range of about 10 μm to about 100 μm. Preferably, the graphite may have the particle size in the range of about 15 μm to about 100 μm. More preferably, the graphite may have the particle size in the range of about 15 μm to about 50 μm.

The particle size of the graphite may be increased so that reactivity of SiO gas to be described below and the graphite may be reduced.

The gas generated during the reaction may be discharged through an exhaust port connected to the reaction container 30.

A heating member is interposed between the adiabatic member 20 and the reaction container 30 to heat the reaction container 30. The heating member may supply heat to the reaction container 30 through various schemes. For example, the heating member may generate heat by applying a voltage to the graphite.

For example, the vacuum heat treatment apparatus may act as an apparatus for preparing silicon carbide to obtain the silicon carbide by heating a mixed raw material comprising a carbon source and a silicon source. However, the embodiment is not limited thereto.

The particle of the graphite in the reaction container may be limited to the range of about 10 μm to about 100 μm, preferably, about 15 μm to about 100 μm, or more preferably, about 15 μm to about 50 μm.

Reaction of the SiO gas and the graphite may be changed according to the particle size of the graphite. The reactivity of SiO gas penetrating through pores between graphite particles and the graphite may be reduced by increasing the particle size of the graphite. Accordingly, generation of silicon carbide being a reaction product by the reaction may be reduced.

In this case, when the particle size of the graphite powder exceeds 100 μm, a fracture strength of the reaction container is degraded so that other problems may occur. Accordingly, the particle size is limited to less than or equal to 100 μm.

Therefore, because the reaction container fabricated according to the embodiment may make the particle size of the graphite powder large to reduce a reaction product by the reaction, crack or breakage due to the difference of thermal expansions between the silicon carbide serving as a reaction product and the graphite may be reduced.

Therefore, the crack and breakage of the reaction container can be prevented so that the manufacturing efficiency can be improved and the manufacturing cost can be reduced by reducing the replacement or repair work of the reaction container when manufacturing a silicon carbide powder by using a vacuum heat treatment apparatus comprising the reaction container.

Any reference in this specification to “one embodiment,” “an embodiment,” “example embodiment,” etc., means that a particular feature, structure, or characteristic described in connection with the embodiment is comprised in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1-4. (canceled)

5. A vacuum heat treatment apparatus for the production of silicon carbide comprising:
a chamber;
a reaction container in the chamber;
mixed source materials in the reaction container; and
a heat member heating the reaction container in the chamber,
wherein the mixed source materials comprise a carbon source and a silicon source,
wherein the reaction container comprises graphite, and the graphite has a particle size in a range of about 10 μm to about 100 μm.

6. The vacuum heat treatment apparatus of claim 5, wherein the graphite has the particle size in a range of about 15 μm to about 100 μm.

7. The vacuum heat treatment apparatus of claim 5, wherein the graphite has the particle size in a range of about 15 μm to about 50 μm.

8. The vacuum heat treatment apparatus of claim 5, further comprising an adiabatic member in the chamber.

9. The vacuum heat treatment apparatus of claim 8, wherein the adiabatic member comprises graphite.

10. The vacuum heat treatment apparatus of claim 5, wherein a mixed raw material comprising a carbon source and a silicon source is received in the reaction container, and silicon carbide is prepared by heating the mixed raw material.
